(19) United States
(12) Patent Application Publication
(10) Pub. No.: US 2009/0267338 A1
(43) Pub. Date: Oct. 29, 2009

(54) VEHICLE TRAILER INTEGRAL CROSS TUBES

(75) Inventor: Denis Gosselin, Saint-Georges (CA)

Correspondence Address: SAND & SEBOLT, AEGIS TOWER, SUITE 1100, 4940 MUNSON STREET, NW, CANTON, OH, 44718-3615, US

(73) Assignee: MAC TRAILER MANUFACTURING, INC., Alliance, OH (US)

(21) Appl. No.: 12/108,122

(22) Filed: Apr. 23, 2008

(51) Int. Cl. B62D 63/06; B62D 21/00

(52) U.S. Cl. 280/789; 280/788

(57) ABSTRACT

A suspension system for use with a vehicle having a frame, two rails longitudinally spaced and secured to the vehicle frame, a hanger bracket depending from each rail, a beam pivotally mounted to each hanger bracket, an axle secured to and intermediate the beams, a support plate secured to each rail, a rail plate secured to each rail, and a bracket plate secured to each bracket. The suspension system includes two cross tubes, each with one end secured to a rail plate and the opposite end secured to the opposing side bracket plate. The system also includes a horizontal tube secured between each bracket plate.

### BACKGROUND OF THE INVENTION

1. Technical Field

The invention relates generally to vehicle trailers. More particularly, the invention relates to a vehicle trailer system that provides reinforcement of frame rails and beams in a trailing beam type of system. Specifically, the invention relates to reinforcement plates welded on the frame rails and hanger brackets of a trailing beam suspension system to provide support for reinforcement cross beams.

2. Background Information

The trucking industry has witnessed a dramatic increase in the cost associated with the transportation of goods. High costs and increased competition mandate that over-the-road vehicles be utilized as efficiently as possible to minimize expense and maximize productivity. Thus, the industry is constantly in search of improvements that can then increase efficiency of trucks and/or reduce the cost of purchasing and operating trucks. Suspension systems are expensive and require maintenance to keep welds and axles in proper working condition. If a weld or axle breaks, the truck is removed from service until proper repairs can be made. This results in costs to the vehicle owner for repairs, as well as lost productivity.

Suspension systems are subjected to a wide variety of loads. Longitudinal loads result from acceleration and braking and are transmitted along the length of the beam to the hanger bushing and hanger bracket. Vertical loads result from a wheel on one side of the truck transversing an obstruction that the corresponding wheel on the other side of the truck does not transverse, such as when one side of the truck transverses a curb. Such differential loading of an axle causing a torque acting about a central axis of the beam to be transmitted along the length of the beam and onto the bushing and hanger bracket. Rotational forces result from compression of the suspension system do to vehicle loading and unloading and due to the vehicle traversing obstructions in the road surface and are transmitted from the wheels to the bushing and hanger bracket by the rotation of the beam about the pin. Lateral loads result from turning of the vehicle and are transmitted along the beam and against the hanger bracket in a direction parallel with the pin. Such loading phenomena differ significantly from each other both as to magnitude and duration.

Reinforcement of the suspension system would be beneficial in reducing load on the hanger brackets and bushings, but is difficult because the variety of internal forces. Constant pushing, pulling, and twisting on any reinforcement mechanism quickly breaks weld seams and renders the mechanism defeated.

Therefore the need exists for a reinforcement mechanism providing varying responses to the multiple loading phenomena experienced by a vehicle suspension, that is inexpensive, easy to install, and has an economical service life.

### BRIEF SUMMARY OF THE INVENTION

In view of the foregoing, the present invention provides for reinforcement of a trailing beam suspension system. The present invention uses metal plates and cross beams to secure each frame rail and frame bracket to one another, reinforcing the suspension system. Metal plates with a hole are welded onto the internal edge of each frame rail. Additional metal plates with two holes are welded onto the internal frame brackets on each side. Two tubular cross members are secured to a frame rail plate at one end and at the opposite end to a hanger bracket plate. A third tubular member is secured at each end to a hanger bracket. Tubular members have tapered ends which include a hole. The holes in each plate and the holes at each end of tubular members allow a pin to pass through and be secured by a nut. This eliminates weld points and further reinforces the structure. As the suspension system undergoes typical load situations, the plates and tubular members allow forces to be distributed among the other non-loaded members of the suspension system. This reduces the likelihood of any one member being over stressed to the point of failure.

### BRIEF DESCRIPTION OF THE SEVERAL VIEWS OF THE DRAWINGS

The preferred embodiment of the presented invention, illustrative of the best mode in which Applicant has contemplated applying the principals of the invention, is set forth in the following description and is shown in the drawings.

FIG. 1 is a side elevational view of a typical truck and trailer;

FIG. 2 is a side elevational view of the improved trailing beam suspension system of the present invention;

FIG. 3 is a rear elevational view of the suspension system shown in FIG. 2;

FIG. 4 is a fragmentary top elevational view of the suspension system shown in FIG. 2 taken along line 4-4 of FIG. 3; and

FIG. 5 is a fragmentary side elevational view of the suspension system shown in FIG. 2 taken along line 5-5 of FIG. 3.

Similar numbers refer to similar parts throughout the drawings.

### DETAILED DESCRIPTION OF THE INVENTION

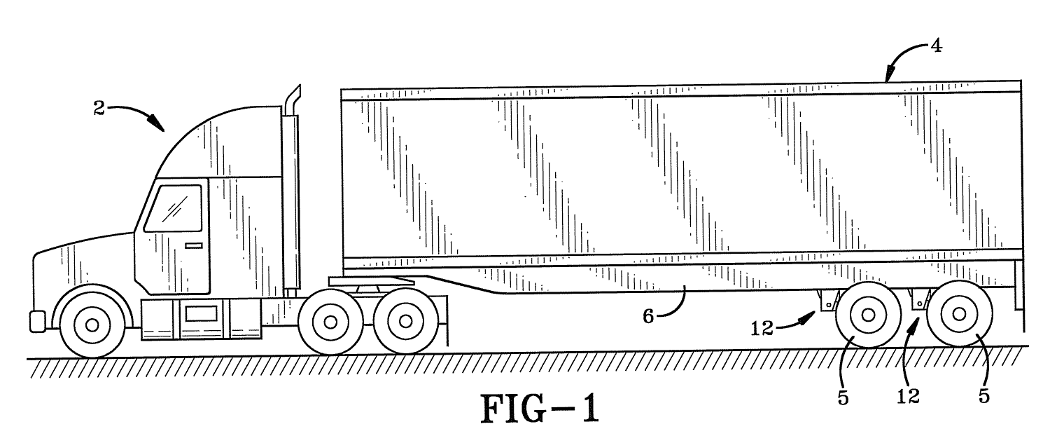

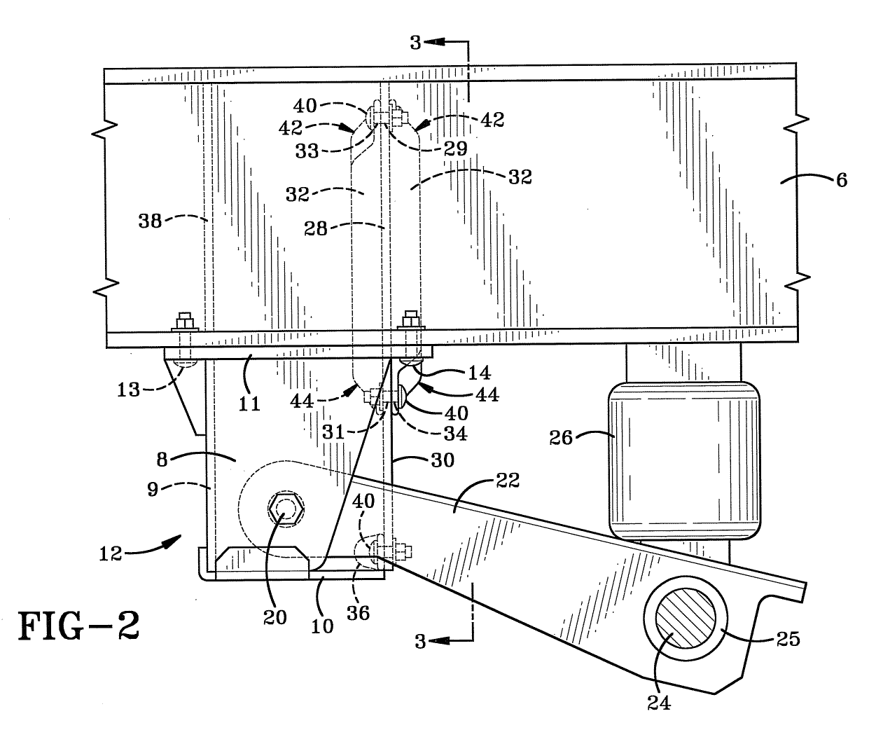

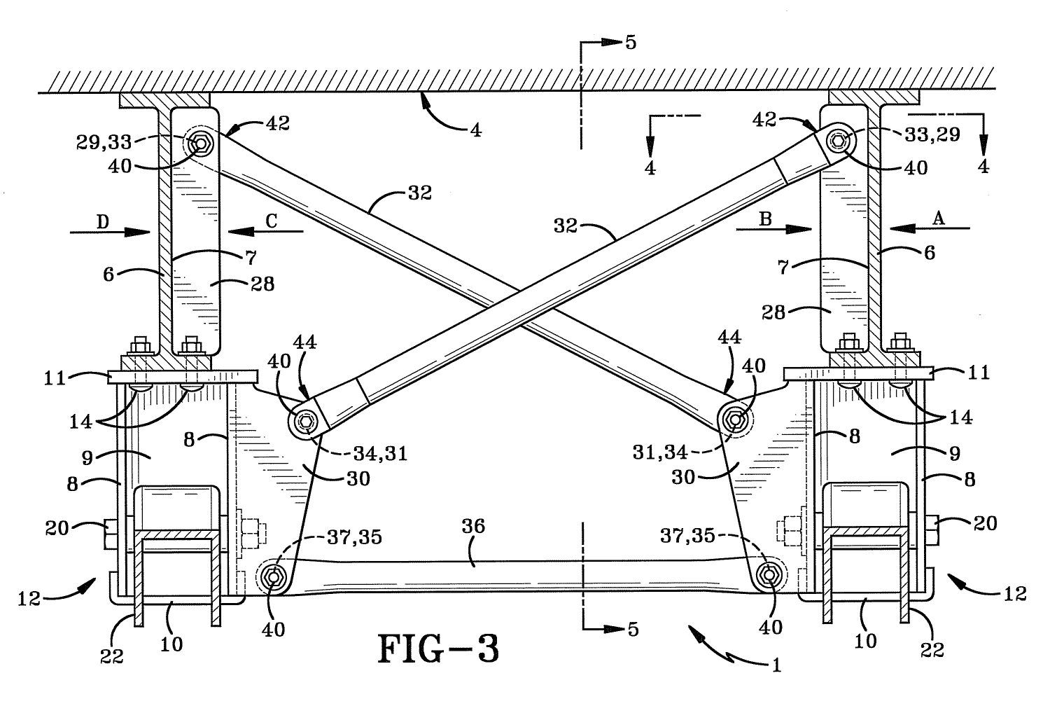

The vehicle trailer with integral cross tubes of the present invention is indicated generally by numeral 1 in FIG. 3, and is particularly shown in FIGS. 2-5. System 1 is a component of a suspension system 12. Shown in FIG. 1, a vehicle 2 includes a cargo box 4 supported by a pair of frame rails 6 extending longitudinally along the length of cargo box 4. A plurality of rotatably mounted wheels 5 are secured to cargo box 4 by suspension system 12.

As shown in FIGS. 2-3, suspension system 12 includes a pair of parallel and spaced apart hanger brackets 8 welded to a top plate 11, a bottom plate 10, and a back plate 9. Top plate 11 is secured to frame rails 6 by pins 13 and 14. A pin 20 pivotably attaches a beam 22 to the lower end of each hanger bracket 8. An air spring 26 connects to beam 22 at an end opposite its connection to hanger brackets 8 and extends between beam 22 and frame rail 6. An axle 24 is welded in axle seat 25 and extends substantially perpendicular to beams 22. FIG. 2 shows only one side of suspension system 12, the other side being substantially identical.

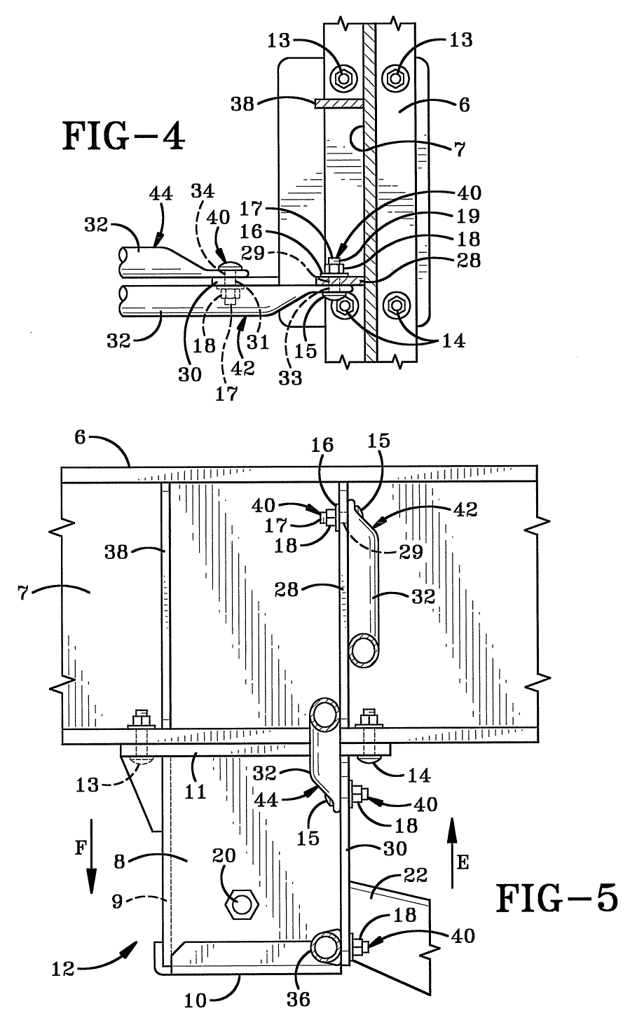

In accordance with the invention, and shown in FIG. 3, an elongated and generally rectangular upper reinforcement plate 28 is welded to an interior surface 7 of each frame rail 6. A lower reinforcement plate 30 extends inwardly and is welded to hanger bracket 8, top plate 11, and bottom plate 10. Shown in FIGS. 4 and 5, an elongated and generally rectangular reinforcement plate 38 is welded to interior surface 7 of each frame rail 6. Reinforcement plate 38 is generally parallel and spaced apart from reinforcement plate 28. Plates 28 and 30 provide a flat surface, perpendicular to frame rail 6, with which to secure an end of a cross tube 32. Cross tube 32 is a hollow, elongated tubular member tapering at each end with a first end 42 having a hole 33, and a second end 44 having a hole 34. Holes 33 and 34 are adapted to accept a pin 40. Shown in FIG. 4, pin 40 includes a head 15, a shank 17, a washer 16 and a plurality of external threads 19 formed thereon which cooperate threadably with a nut 18.

Referring to FIGS. 3-5, a hole 29 in plate 28, proximate cargo box 4, aligns with hole 33 in cross tube 32 allowing pin 40 to pass through 29 and 33 to secure first end 42 of cross tube 32 to plate 28. A hole 31 in plate 30, proximate top plate 11, aligns with hole 34 in cross tube 32 and allows pin 40 to pass through 31 and 34 to secure second end 44 of cross tube 32 to plate 30. Lower reinforcement plate 30 includes a second hole 37 proximate bottom plate 10. Hole 37 in lower reinforcement plate 30 aligns with a hole 35 at each end of a horizontally oriented cross tube 36 allowing pin 40 to pass through 37 and 35 to secure cross tube 36 horizontally between each lower reinforcement plate 30.

In accordance with the invention, and referring to FIG. 3, cross tubes 32 extend between frame rails 6 and opposing hanger brackets 8 and horizontal tube 36 extends between opposing hanger brackets 8. Tubes 32 and 36 reinforce the internal framework of suspension system 12. The present invention improves upon previous suspension systems by securing each frame rail 6 to the opposite hanger bracket 8, and securing opposing hanger brackets 8 to one another directly creating a solid, reinforced internal structure.

Shown in FIGS. 2, 4, and 5, system 1 is reinforced against vertical loads. Vertical loads result from wheel 5 on one side of vehicle 2 traversing an obstruction that the corresponding wheel 5 on the other side of vehicle 2 does not traverse, such as a curb. Vertical loads can also result from compression of suspension system 12 due to vehicle 2 loading and unloading or obstruction on the road surface. In system 1, reinforcement plate 28 is co-planer and vertically aligned with reinforcement plate 30 and reinforcement plate 38 is co-planer and vertically aligned with back plate 9. In addition, reinforcement plate 28 and 30 are proximate pin 14, and reinforcement plate 38 and back plate 9 are proximate pin 13. This proximity to pins 13 and 14 and vertical alignment of plates 9 to 38 and 28 to 30 reinforces suspension system 12 against upward (show at arrow E) or downward (shown at arrow F) pressure from terrain or movement of vehicle 2.

Shown in FIG. 3, system 1 is reinforced against lateral loads. Lateral loads result from turning of vehicle 2 and are transmitted along beam 22 and against hanger bracket 8 in a direction parallel with pin 20. In system 1, cross tubes 32 provide a horizontal buttress from the frame rails 6 to the opposite hanger brackets 8 and horizontal tube 36 provides a horizontal buttress between opposing hanger brackets 8. Typically, horizontal forces on hanger brackets 8 or frame rails 6 are transferred into axle 24, cargo box 4, and various welds in system 12. In system 1, a force such as arrow A encounters a buttressed resistance from tubes 32 and 36 pushing against opposing reinforcement plates 28 and 30. A force such as arrow B encounters a resistance from tubes 32 and 36 pulling on plates 28 and 30. In both scenarios, as an improvement from previous systems, force is distributed among other members of system 1 and suspension system 12, reducing the load on any one member.

Shown in FIGS. 2-5, suspension system 12 is typically referred to as a “trailing beam” suspension system. In the present invention, any trailing beam suspension system will benefit from suspension hangers with cross tubes 1. One objective of the present invention is to allow system 1 to be added to suspension system 12 at any time during the lifecycle of vehicle 2. This allows vehicle owners to retrofit existing suspension systems to take advantage of the present invention.

Another objective of the present invention is to make system 1 highly adaptable, to allow reinforcement of most trailing beam suspension systems. As such, reinforcement plates 28, 30, and 38 may be any generally flat and rigid shape to conform to a given suspension system. Cross tubes 32 and horizontal tube 36 can be any generally tubular members able to be secured to plates 28, 30, and 38.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A vehicle trailer comprising:
a first and second rail;
a first beam pivotally mounted to a first hanger bracket depending from the first rail;
a second beam pivotally mounted to a second hanger bracket depending from the second rail;
a first cross tube having first and second spaced apart ends, and wherein the first end is secured to the first rail and the second end is secured to the second hanger bracket; and
a second cross tube having first and second spaced apart ends, and wherein the first end is secured to the second rail and the second end is secured to the first hanger bracket.

2. The vehicle trailer as defined in claim 1, further comprising a horizontal tube having first and second spaced apart ends, and wherein the first end is secured to the first hanger bracket, and the second end secured to the second hanger bracket.

3. The vehicle trailer as defined in claim 1, further comprising a first and second rail plate, and wherein the first rail plate is secured to the first rail and the second rail plate is secured to the second rail.

4. The vehicle trailer as defined in claim 3, further comprising a first and second bracket plate, and wherein the first bracket plate is secured to the first hanger bracket, and the second bracket plate is secured to the second hanger bracket.

5. The vehicle trailer as defined in claim 4, wherein the first cross tube is secured intermediate the first rail plate and the second bracket plate, and wherein the second cross tube is secured intermediate the second rail plate and the first bracket plate.

6. The vehicle trailer as defined in claim 5, wherein an end of the first cross tube is secured to the first rail plate, and an opposite end of the first cross tube is secured to the second bracket plate.

7. The vehicle trailer as defined in claim 6, wherein an end of the second cross tube is secured to the second rail plate, and an opposite end of the second cross tube is secured to the first bracket plate.

8. The vehicle trailer as defined in claim 7, wherein an end of the horizontal tube is secured to the first bracket plate, and an opposite end of the horizontal tube is secured to the second bracket plate.

9. The vehicle trailer as defined in claim 8, further comprising a third and fourth rail plate, and wherein the third rail plate is secured to the first rail and spaced apart from the first rail plate, and the fourth rail plate is secured to the second rail and spaced apart from the second rail plate.

10. The vehicle trailer as defined in claim 9, wherein the first, second, third, and fourth rail plates extend perpendicularly and intermediate the first and second rails.

11. The vehicle trailer as defined in claim 8, wherein the first and second bracket plates extend perpendicularly and intermediate the first and second hanger brackets.

12. A suspension system comprising:
a first hanger bracket;
a first beam pivotally mounted to a first hanger bracket;
a second hanger bracket;
a second beam pivotally mounted to a second hanger bracket;
a first cross tube adapted to extend intermediate the trailer and the second hanger bracket; and
a second cross tube adapted to extend intermediate the trailer and the first hanger bracket.

13. The suspension system as defined in claim 12, further comprising a horizontal tube having first and second spaced apart ends, and wherein the first end is secured to the first hanger bracket, and the second end secured to the second hanger bracket.

14. The suspension system as defined in claim 13, further comprising a first and second bracket plate, and wherein the first bracket plate is secured to the first hanger bracket, and the second bracket plate is secured to the second hanger bracket.

15. The suspension system as defined in claim 14, wherein an end of the first cross tube is adapted to be secured to the vehicle, and an opposite end of the first cross tube is secured to the second bracket plate.

16. The suspension system as defined in claim 15, wherein an end of the second cross tube is adapted to be secured to the vehicle, and an opposite end of the second cross tube is secured to the first bracket plate.

17. The suspension system as defined in claim 16, wherein an end of the horizontal tube is secured to the first bracket plate, and an opposite end of the horizontal tube is secured to the second bracket plate.

18. The suspension system as defined in claim 17, wherein the first and second bracket plates extend perpendicularly and intermediate the first and second hanger brackets.

19. The suspension system as defined in claim 18, further comprising a first and second rail plate, spaced apart and adapted to extend from the vehicle.

20. The suspension system as defined in claim 19, wherein an end of the first cross tube is secured to the first rail plate and an opposite end of the first cross tube is secured to the second bracket plate, and an end of the second cross tube is secured to the second rail plate and an opposite end of the second cross tube is secured to the first bracket plate.
